(19) United States
(12) Patent Application Publication
(10) Pub. No.: US 2024/0208593 A1
(43) Pub. Date: Jun. 27, 2024

(54) FOLDING INFLATABLE VEHICLE

(71) Applicant: Benoit PAYARD, Billom (FR)

(72) Inventor: Benoit PAYARD, Billom (FR)

(21) Appl. No.: 18/288,566

(22) PCT Filed: Apr. 28, 2022
(86) PCT No.: PCT/EP2022/061416

§ 371 Date: Oct. 26, 2023

(30) Foreign Application Priority Data
Apr. 29, 2021 (FR) FR2104460
Apr. 30, 2021 (FR) FR2104595

(51) Int. Cl. B62D 39/00

(52) U.S. Cl. CPC B62D 39/00

(57) ABSTRACT

The present invention is a folding inflatable vehicle (1000) of which only the wheel-supporting brackets (400) and the wheel (500) are not inflatable. Said wheel-supporting brackets are held in place by the inflation pressure of certain parts of the vehicle. The motors (11) and the energy store (515, 516, 600) are at the wheels (500). The controls (850) are removable. The invention is particularly intended for the manufacture of novel folding inflatable vehicles that have a low weight, low energy consumption, take up little storage space, and at the same time have a low production cost, while making repairs easier and increasing design options.

The object of the present invention is to create a foldable inflatable vehicle, with a passenger compartment, where only the wheel support frames and the wheel are not inflatable. These wheel support frames are held by the inflation pressure of certain parts of the vehicle. The motors and the energy storage are at the wheels and the wheel support frame. The controls are removable, such as turning, accelerating, braking, lights and klaxon.

### TECHNICAL FIELD

The present invention relates to a foldable inflatable vehicle which is as lightweight as possible and which takes the minimum of deflated space.

### Previous Invention

There is a search for lightening the vehicles, the first vehicles, in particular scooters, can be seen with an inflatable chassis and speeds of less than 10 km/h. There are also patents for an inflatable dummy vehicle and others where only part of the structure is inflatable.

### Resume of the Invention

To achieve its aim, the invention proposes the various solutions that can be used separately or partially combined or all assemblies depending on the advantages that it is desired to put forward, in particular a solar electric foldable inflatable vehicle, only the wheel support frames and the wheel are not inflatable.

### Technical Problem

The vehicles are heavy, which implies a high energy consumption; moreover, they take place for transportation and storage; then any small impact leads to significant repair costs; finally, it is not easy to change the design of its own vehicle.

### Solution of the Problem

The entire upper structure, that means, all that is above the floor or chassis, is inflatable and has at least one inflatable passenger compartment, it is fixed on the low platform and the upper structure is composed of inflatable beams and uprights, fabric doors and/or a fabric grille and/or sides partially closed by the fabric body, which make it possible to partially close the passenger compartment.

The seats are incorporated into the upper structure in order to reduce the space requirement and the cost.

The floor is inflatable, entirely flat and begins at the front and finished at the rear of the vehicle.

An inflatable platform frame made up of several inflatable elements, assembled together, some inflatable elements have a pressure relief valve with different levels of triggering, in order to guide, in the event of shocks, the deformation by elements which deflate first, others, and others which must keep the rigidity of the passenger compartment. These inflatable elements can be used to frame and hold the engine support structure and or the structure to hold the wheels.

The controls are removable and may in particular be a handle, a steering wheel, pedals or a handle.

The wheel support chassis is composed of a solid form comprising at least one U which is maintained in the inflatable form, such as a vise, by the inflation pressure of inflatable form, at least one safety may be added, in order to ensure the positioning and increase the partial or permanent retention. For example, at least one axle support, integral with the inflatable form, which is traversed by an axis, integral with the solid form of the wheel support chassis, said axis is oriented towards the wheel so that the assembly and disassembly of the invention is possible only when the inflatable form is deflated.

The motor elements (s), energy storage zones, brake (s) for operating the vehicle are in the wheels, theses wheels also have flashing elements and the cables connect all the wheels together.

The mudguard is an energy reserve mudguard and serves as a mudguard and as a reserve of energy, it adapts to all the wheels of the vehicle; connections between the various energy reserve mudguards make it possible to form a common reserve of energy. The energy reserve mudguard can be doubled in order to increase the common reserve.

A portion of the envelope of the vehicle, composed of two fabric walls, may change colour. The light sources may be inside the two walls or on the outside against the walls or both.

Braking is carried out using the electric motor (s), it is an electrical system that uses regenerative braking coupled with braking by current injection. A mechanical brake can be used to immobilize the vehicle at a standstill and in the event of a power outage, this brake can be a brake with a lack of current. The braking by current injection can be replaced by regenerative braking and a heat sink for the energy generated to manage when the battery is full. It is also possible to add a management of the energy reserve at four levels: empty, low, high, full with reduction actions or energy consumption.

The folding solar panels cover or compose certain portions of the envelope or of the inflatable structure of the vehicle.

When all the solutions presented above are combined, the invention is a solar electric foldable inflatable vehicle which is as lightweight as possible and takes the minimum of deflated space.

### Advantageous Effects of the Invention

Advantageously, the invention makes it possible to reduce the weight and energy consumption, low production costs, simple repairs and to take less space for its transport or storage.

The other great advantage of the invention is modularity, in fact as the inflatable floor is flat, this makes it possible to choose where to place the driver, the passengers, the trunk, the bucket, etc. and for the same floor, it is possible to have several designs.

Another benefit of the invention is the safety. Indeed, as there is one or more inflatable elements with pressure relief valves set at different pressures, it is possible to control the deformation of the vehicle during an impact, this reduces the consequences for the vehicle and for the persons inside.

When the controls are a handle with management buttons, this makes it possible to be even lighter, to take less space, it is easy to install and especially the vehicle is then usable for disabled persons or not.

Another benefit of the invention is that the wheel support frame makes it possible to fix a wheel by the simple fact of the inflation pressure, of the inflatable shape in itself, in addition to this solution, wheels are fixed on shapes of different widths. Furthermore, if the pressure of the inflatable form to be transported is high, it is possible to have a better hold and increase the running speed.

Another benefit of the invention is the possibility of changing its vehicle at a lower cost. Indeed, by keeping the same wheels and wheel support, it is possible to put a wider floor or a different upper shape. Thus, certain parts can be made longer and can also be recycled more easily; this reduces the ecological impact of the vehicle while lowering the costs of changing his vehicle.

The invention also makes it possible to configure its vehicle by adding energy reserve mudguards, indeed these are mounted on all the wheels, which makes it possible to increase the autonomy of the vehicle.

In addition, the invention makes it possible to change the colour of the vehicle at the level of the envelope of the vehicle, which may be inflatable.

At the level of safety, the invention makes it possible to eliminate the influence of atmospheric conditions by eliminating the mechanical contact of the brakes, while suppressing mechanical braking noises.

And to finish the invention is partially autonomous thanks to the solar panels.

The details of various embodiments of the present invention, both in terms of their structure and operation, can be extracted in part by studying the drawings, in which the same reference numbers designate identical parts, and in which:

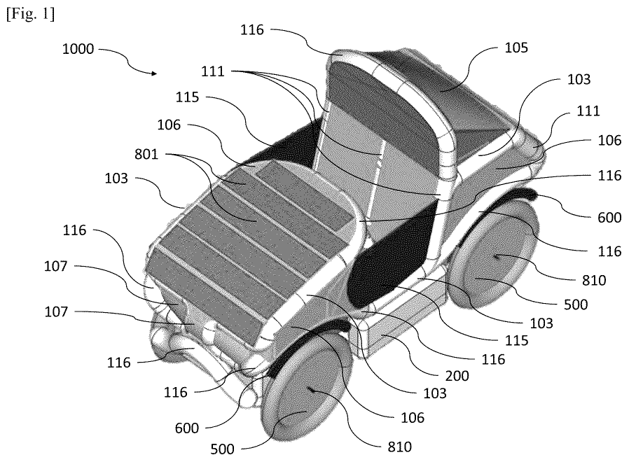

FIG. 1 is a front three-quarter view of the invention

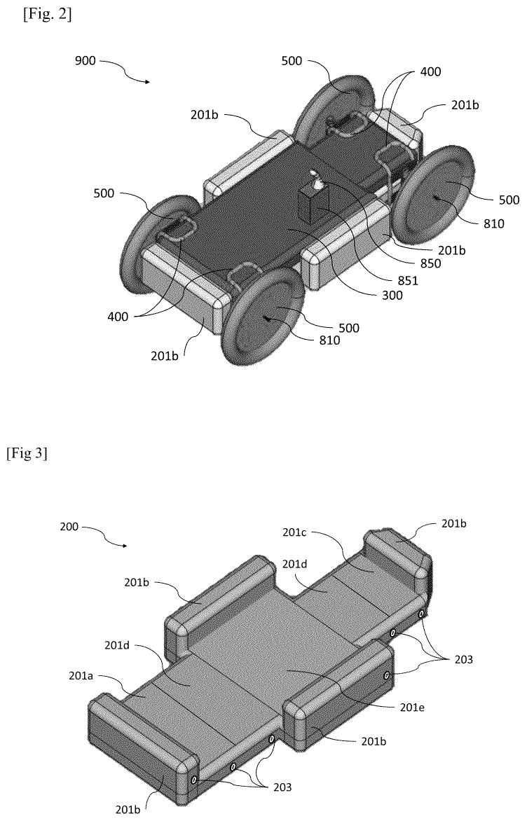

FIG. 2 is the front three-quarter view of the lower part of the invention

FIG. 3 is the front three-quarter view of the chassis of the invention

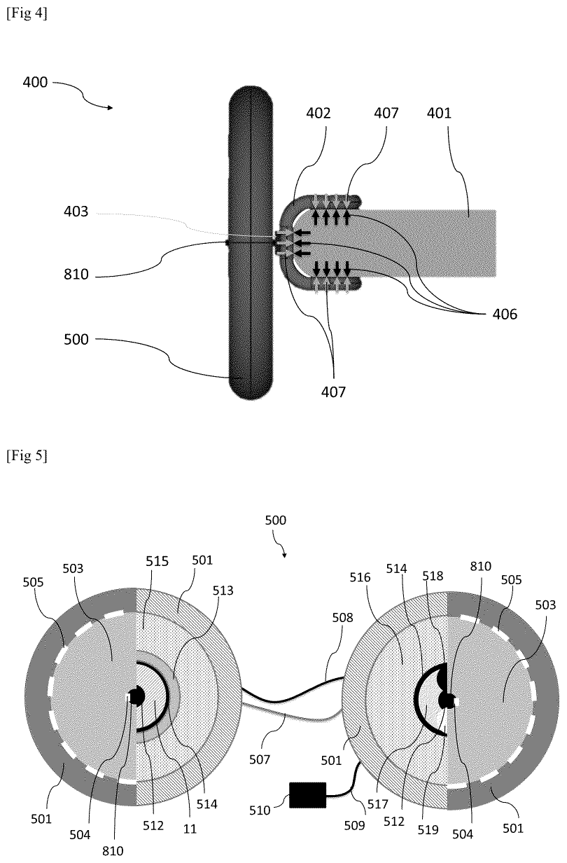

FIG. 4 is the cross-sectional view of the side of the wheel support frame

FIG. 5 is the side view in partial cross-section of the wheel motors and their connections

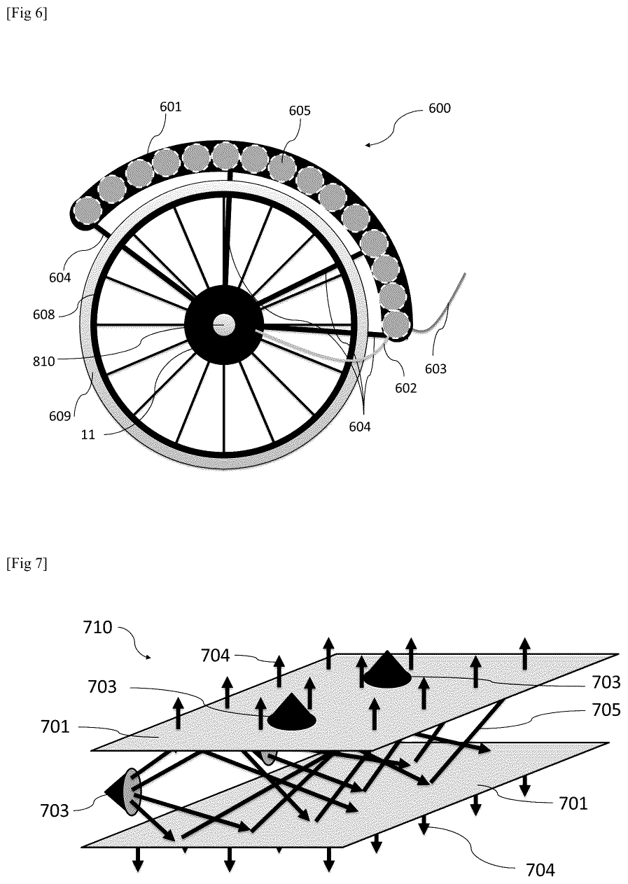

FIG. 6 is the side view in section of the energy reserve mudguard

FIG. 7 is the three-quarters view of the diagram of the luminous structure

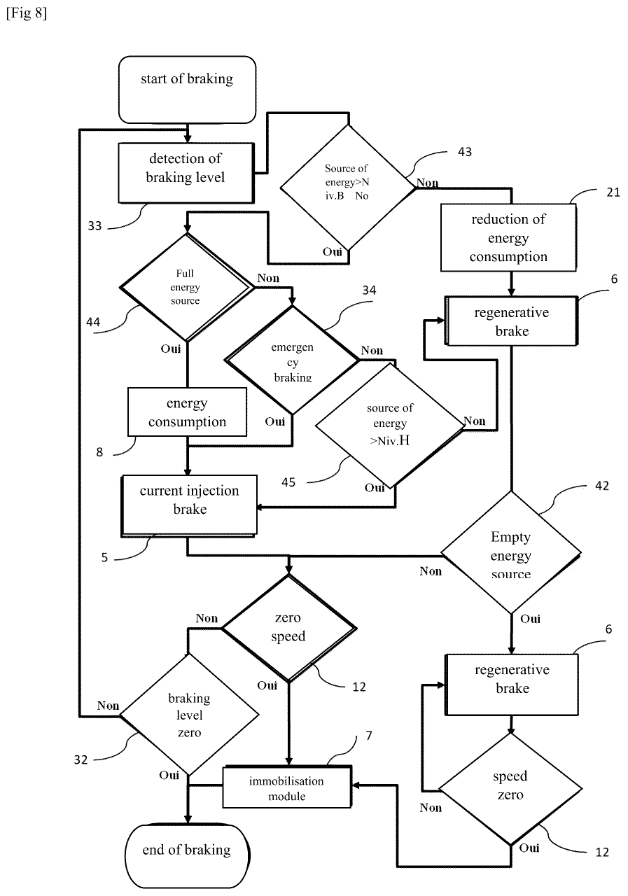

FIG. 8 is the flow chart of the braking solution of an electric vehicle

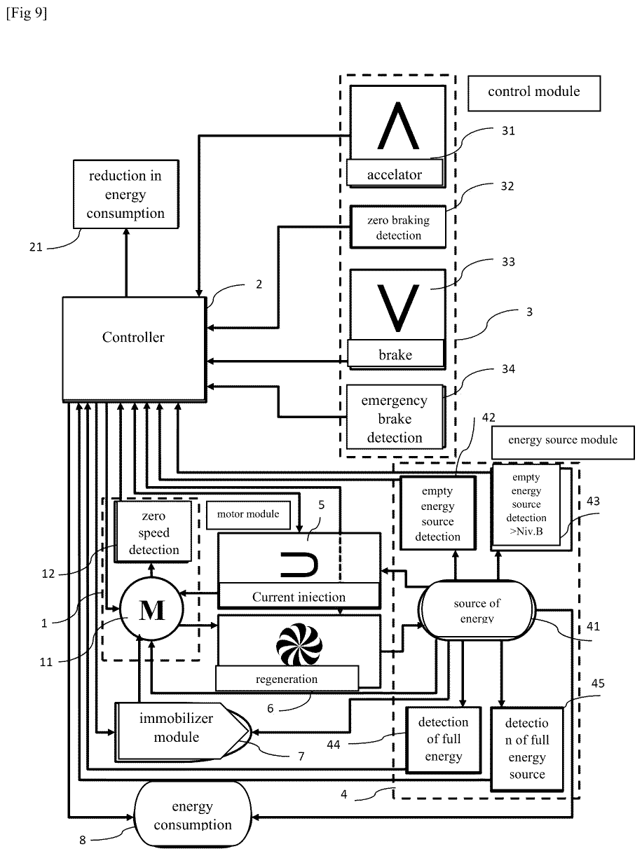

FIG. 9 is the block diagram of the braking solution of an electric vehicle

### DESCRIPTION OF EMBODIMENTS

The inflatable forms have a minimum and maximum pressure.

And/or the vehicle comprises at least: a motor, a chassis, wheels, a floor, a passenger compartment.

And/or the vehicle has the entire inflatable upper structure, that is to say all what is above the floor or the chassis, with at least one inflatable passenger compartment.

And/or the vehicle is electric and inflatable.

And/or the electric vehicle is regeneration of current.

FIG. 1 a perspective view of three-quarters front of the invention, illustrates a vehicle (1000) having the entire inflatable upper structure, that means all what is above the floor or the chassis, composed of at least one inflatable passenger compartment fixed to the lower platform (900), this upper structure comprises beams (103) and/or uprights (111) and/or the beams (116) in the form of an arc of a circle, all inflatable, connected to one another, fabric doors (115) and/or a fabric grille (107) and/or sides partially closed by the fabric body (106), which make it possible to partially close the passenger compartment. This inflatable upper structure is partially covered or composed of solar panels (801).

FIG. 2 Seen from three-quarters front of the bottom part of the invention illustrates the lower part (900) which has a flat inflatable floor (300) going from the front to the rear of the vehicle placed on an inflatable platform chassis (200) of which the side elements (201b) are seen, all connected to the wheels (500) by wheel support frames for inflatable form (400), as well as the removable controls (850) and their support (851) In the illustration, the removable controls (850) are a handle with buttons on top of the lights, the turn signals, the warning, the horn and the reverse gear.

FIG. 3 Seen from three-quarters front of the chassis of the invention, illustrates an inflatable platform chassis (200) composed of several inflatable elements (201), assembled together, some of which have a pressure relief valve (203) with different levels of triggering, in order to guide, in the event of shocks, the deformation by elements which deflate first (201b), other in succession (201c), (201a) and others (201d), (201e) which must keep the rigidity of the passenger compartment.

FIG. 4 seen in section on the side of the wheel support frame illustrates this wheel support frame for inflatable form (400) composed of a solid shape comprising at least one U (402), of an inflatable shape (401) and of a reinforcement (403), said reinforcement (403) allows the attachment of the axis (810) of the wheel (500), the solid form (402) is maintained in the inflatable form (401), such as a viseby the inflation pressure (406) which presses the inflatable form (401) onto the solid form (402) and the reciprocal pressure (407) of the solid form (402) on the inflatable form (401).

FIG. 5 seen from the partial sectional side of the wheel motors and their connections illustrates, two wheels, at least one motor (11), a main storage area (516) and a secondary energy storage area (515), a brake (512), a power transmission cable (507) for connecting the wheels together and for powering the motor (s) (11), a data management cable (508) for communicating with the wheel elements and managing the wheel motors, an interface of the controls of the vehicle (510), wheel axes (810). The motor elements (11), storage areas (516) (515) of the energy, brake (s) (512) for operating the vehicle are in the wheels, said wheels also have flashing (505) and the cables (507) (508) connect all the wheels together, a control cable (9) exits one of the wheels to connect the interface of the controls (510).

FIG. 6 seen from the side in section of the energy reserve mudguard illustrates a wheel, at least one motor (11), wheel axles (810), an energy reserve mudguard (601). The energy reserve mudguard (601) serves as a mudguard and as a reserve of energy. Each energy reserve mudguard (601) being integral with the body of the vehicle, at the level of the axis (810) of a wheel, by means of supports (604); the energy reserve mudguard (601) fits over all the wheels of the vehicle.

FIG. 7 seen from three-quarters of the diagram of the luminous structure illustrates a part of the envelope of the vehicle, which can be inflatable, this part comprises two translucent fabric walls (701), separated from each other, and one or more light sources (703) near the walls (701), which allow a diffusion of the light (705) between the two walls (701) and a uniform light flux (704) which leaves the envelope (710).

FIGS. 8 and 9 respectively the flowchart and the principle diagram, illustrate a braking solution of an electric vehicle, having an engine module (1), a controller (2), a control module (3), an energy source module (4), the engine module (1) has at least one engine (11) and a zero speed detector (12) of said engine (11), the control module (3) has at least one accelerator (31), a zero braking detector (32), a brake (33) and an emergency braking detector (34), the energy source module (4) has at least one energy source (41), an empty energy source detector (42), an energy source detector>Niv. B (43), energy source detection>Niv. H (45) and a solid energy source detector (44), a current injection module (5), a regeneration module (6), a power consumption module (8), a power consumption reduction module (21), an immobilization module (7) braking is carried out using the electric motor (s) (11), the braking is an electrical system that uses regenerative braking (6) coupled to a braking by current injection (5). When the energy source is greater than Niv. H (45) the power consumption module (8) is triggered, when it is less than Niv. B (43) the energy consumption reduction module (21) is triggered. A mechanical brake can be used to immobilize (7) the vehicle at a standstill and in the event of a power outage, this can be a brake with a lack of current. The braking by current injection (5) may also be replaced by regenerative braking (6) and a heat sink for the energy generated to manage when the battery is full. The flowchart, [FIG. 8], makes it possible to understand the operating logic and the block diagram, [FIG. 9], the link between the various components.

The vehicle (1000) is a solar electric folding inflatable vehicle (1000), having all the elements of the preceding descriptions, the inflatable upper structure of which is fixed to the lower platform (900) which contains at least one chassis (400), the two translucent fabric walls (701) are the two tubes forming the beams (103, 116) and the uprights (111), the inflatable form (401) is composed of an inflatable chassis (200) and an inflatable floor (300), the brake (512) is an electrical system that uses regenerative braking (6) coupled to a current injection braking (5), the energy reserve mudguard (601) is connected to the motor (11) and to the controller (2), the solar panels (801) are indirectly connected to the motor (11), the removable controls (850) and their support (851) are connected to the control interface (510).

The invention is particularly intended to manufacture new foldable inflatable vehicles with reduced weight and energy consumption, having a low production cost, facilitating repairs, while increasing the possibilities of design.

### PATENT DOCUMENTS

FR2948577A3
GB2496443A
CN201193080Y
DE29719770U1
DE4239120A1
DE10200900558A1
DE102005034771A1
JP3443405B2
US2015291085A1
DE19529884A1
DE102019004710A1
CN201712528U
EP3549822A1
JP2015220026A
ZO2005025275A1
EP1316495A1
GB2552996A
AU2017100719A4
EP0180705A1
U.S. Pat. No. 8,141,888B1
FR1509071A
DE29719770U1
JPH02117419A
WO2007118193A2
U.S. Pat. No. 5,692,795A
WO2011121122A1
CN205675146U
U.S. Pat. No. 1,144,463A
US2015014080A1
CN106005225A
DE102018123206A1
WO2006074627A1
DE102008000146A1
DE102015225956A1
WO2006097499A2
AT522121B1
EP3832878A1
WO2013070153A1
EP3242120A1
FR3055277A1
WO02078192A1
DE102015114689A1
EP1503933A1
US2017305261A1
US2013069420A1
WO2016119022A1
US200943438A1
CN102795269A
GB2496443A

1. A vehicle comprising at least one frame (400), this frame is composed at least of a U-shape (402) and an inflatable shape (401), the vehicle is characterized in that the U-shape (402) is held in the inflatable shape (401) by the inflation pressure (406) which presses the inflatable shape (401) onto the U-shape (402).

2. A vehicle according to claim 1, characterized in that it has an inflatable upper structure.

3. The vehicle according to claim 1, characterized in that it has an envelope, said envelope comprises a portion with two translucent walls (701), separated from each other, and one or more light sources (703) near the walls (701), which allow a diffusion of the light (705) between the two walls (701) and a uniform light flux (704) which exits the envelope (710).

4. The vehicle according to claim 1, characterized in that the inflatable shape (401) is an inflatable platform frame (200) composed of several inflatable elements (201), assembled together, some inflatable elements (201) have a pressure relief valve (203) with different levels of triggering, in order to guide, in the event of shocks, the deformation by elements which deflate first (201b), other in succession (201c), (201a) and others (201d), (201e) which must keep the rigidity of the passenger compartment.

5. The vehicle according to claim 1, characterized in that the inflatable shape (401) is an inflatable floor (300).

6. Vehicle according to claim 1, characterized in that, in order to operate the vehicle, in at least one wheel (500) connected to the chassis (400): at least one motor element (11), at least one energy storage area (516)/(515) and at least one brake (512).

7. Vehicle according to claim 1, characterized in that the vehicle has at least one motor (11) and that the braking is carried out by means of the motor (s) (11).

8. Vehicle according to claim 1, characterized in that it has a brake with a lack of current.

9. The vehicle according to claim 1, characterized in that it is a vehicle (1000) that it has at least one motor (11), at least one energy storage area (516)/(515), at least one brake (512) and at least one upper structure which is fixed on a low platform (900), this low platform including at least one chassis (400), there are also controls (850) and their support (851) which are connected to a control interface (510).

10. Vehicle according to claim 1, characterized in that it may be, in part, covered with solar panels (801).

11. Vehicle according to claim 1, characterized in that the vehicle has at least one energy reserve mudguard (601).
